(19) United States
(12) Patent Application Publication
(10) Pub. No.: US 2011/0043804 A1
(43) Pub. Date: Feb. 24, 2011

(54) MATERIAL ANALYSIS DEVICE BASED ON EDGE-EMITTER SEMICONDUCTOR LASER CHRYSTAL, AND ASSICIATED ANALYSIS TOOL

(76) Inventors: Huw Summers, Murton (GB); Paul Rees, Glanmor Road (GB)

Correspondence Address: REISING ETHINGTON P.C., P O BOX 4390, TROY, MI, 48099-4390, US

(21) Appl. No.: 12/746,463

(22) PCT Filed: Dec. 5, 2008
(86) PCT No.: PCT/GB2008/004033

§ 371 Date: Oct. 25, 2010

(30) Foreign Application Priority Data
Dec. 6, 2007 (GB) 0723893.4

(51) Int. Cl. G01N 21/25; H01S 3/16; G01J 1/42

(52) U.S. Cl. 356/416; 372/41; 356/218

(57) ABSTRACT

An edge-emitter semiconductor laser crystal having a receptacle for sample material which can influence the crystal's laser operation. There may be separate zones of laser action within the crystal, creating respective sensing zones in the receptacle. Detection may be achieved by providing photo-diode regions within the crystal, for example.

The invention relates to the use of electromagnetic radiation to investigate a sample substance. In particular, the invention relates to the investigation of a sample substance by locating it in close proximity to semiconductor laser material.

Semiconductor laser crystals are widely known and fall into two general classes: edge-emitter and surface-emitter. To explain briefly the difference between these classes, it is useful to consider a semiconductor laser crystal in the form of a cube with connections on opposing faces of the cube for supplying electrical energy to the crystal to drive the laser action. If the laser light emitted through this pair of faces is being harnessed then the crystal is being used as a surface-emitter. On the other hand, if laser light from one or more of the other four surfaces of the cube is being harnessed then the crystal is being used as an edge-emitter.

It is known to pass to biological cells over a laser light emitting surface of a surface emitter type semiconductor laser crystal and to investigate the laser light for perturbations caused by the cells. These perturbations can be used to make deductions about the nature of the cells.

According to one aspect, the invention provides a semiconductor laser crystal of edge-emitter type with a receptacle formed in the crystal, in which receptacle can be located sample material to be studied in order to influence the laser operation of the crystal in a detectable manner.

By forming the receptacle in the crystal, a fixed alignment of at least partially reflective surfaces at least partially defining the sample zone is achieved.

In certain embodiments, the receptacle is a channel formed in a surface of the crystal. In such embodiments, it may then be possible to flow material to be studied along the channel. Alternatively, the receptacle could be a pit, for example.

In certain embodiments, a laser crystal according to the invention may be constructed to provide a plurality of sensors. Each sensor requires electrical current to be used to stimulate a distinct zone within the crystal such that the crystal then provides a plurality of lasers, with the receptacle being used to allow sample material to interact with a plurality of these lasers.

In certain embodiments, laser action may be limited to a zone of the crystal which is sufficiently small to restrict the interaction of laser light from that zone to a piece of sample material within the receptacle of dimensions similar to a typical biological cell. In other embodiments, the zone may be smaller still, such that light emitted from the zone is suitable for use in investigating just a part of a biological cell.

In certain embodiments, the crystal forms part of an analysis tool provided with means for detecting light from the crystal's laser operation that has been influenced by sample material in the receptacle. In certain embodiments, the detection means is provided by a region of the crystal that is operated as one or more photodiodes.

By way of example only, certain embodiments of the invention will now be described with reference to the accompanying drawings, in which:

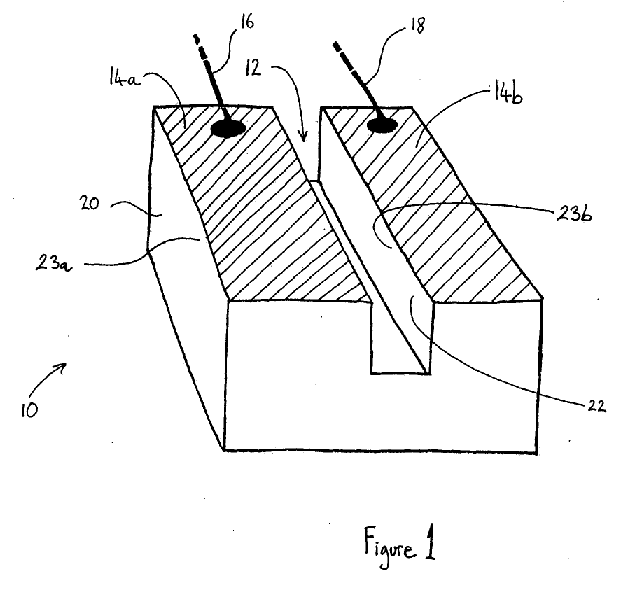

FIG. 1 shows an edge-emitter type semiconductor laser crystal provided with a flow channel;

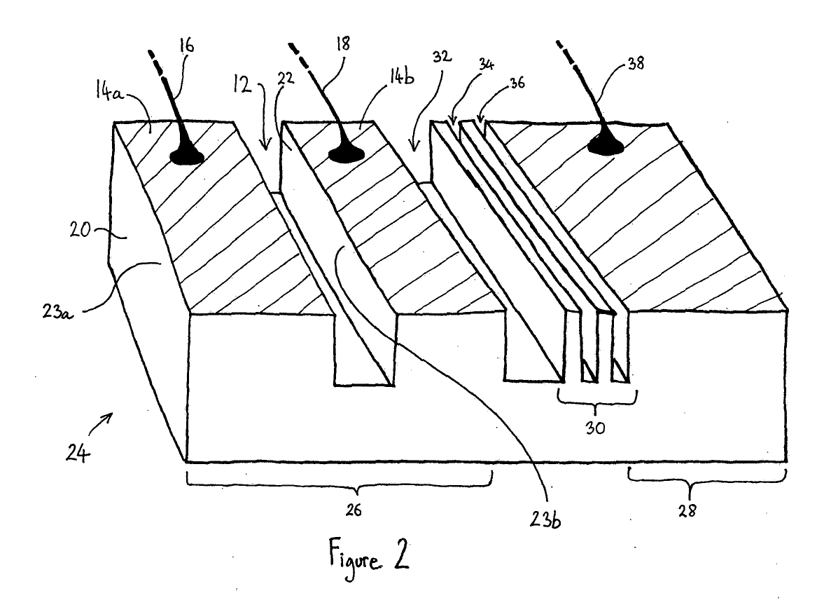

FIG. 2 shows a version of the crystal of FIG. 1 that has been modified to include a light detector zone;

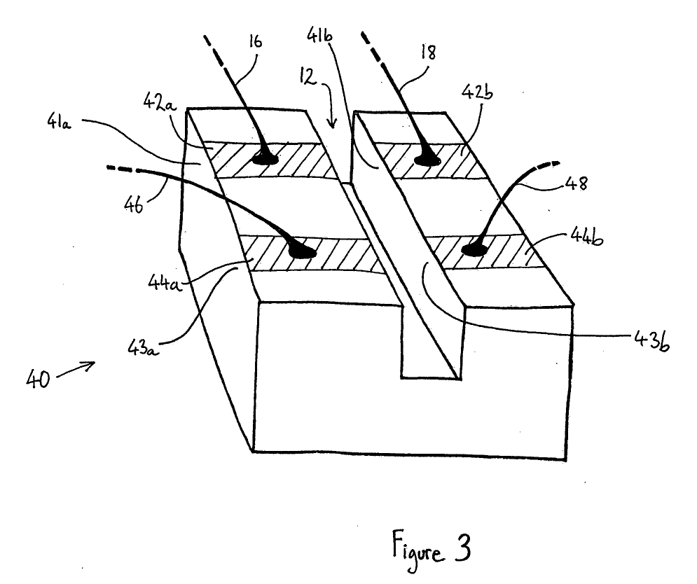

FIG. 3 illustrates a modification of the crystal of FIG. 1, in which the zones of laser action has been subdivided; and

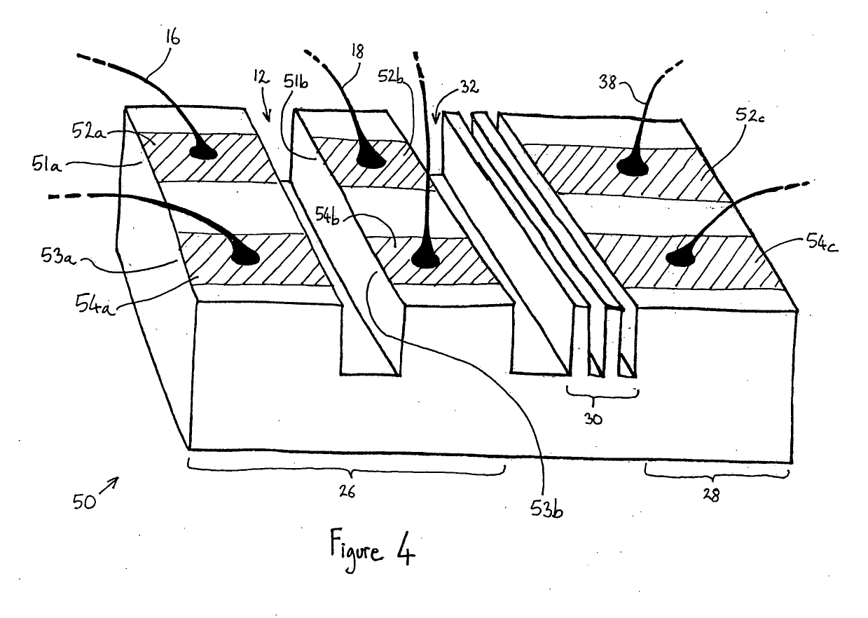

FIG. 4 shows a variant of the crystal of FIG. 2, in which the zones of laser action has been subdivided.

FIG. 1 shows an edge-emitter semiconductor laser crystal 10. In order to achieve laser action, electrical energy is applied to opposing metal coated surfaces of the crystal through suitable electrical contacts. Throughout the figures, metal coated (i.e. “metallized”) surface regions of the crystal 10 are shaded. As shown in FIG. 1, channel 12 is provided in the upper surface of the crystal 10. The channel 12 divides the upper surface of the crystal 10 into two portions 14a and 14b. Due to this subdivision of the metallized upper surface, separate electrodes 16 and 18 are required for making electrical connection to portions 14a and 14b respectively. The underside, i.e. the face opposite the upper surface, is also metallized and has an electrical connection similar to 16 or 18. However, because of the orientation of the crystal 10 in FIG. 1, that metal layer and the associated electrical contact are not shown in FIG. 1.

Face 20 and wall 22 lie parallel to one another. Moreover, the wall of the channel that lies opposite wall 22 also lies parallel to face 20. Additionally, the outer face of the crystal 10 that lies opposite face 20 is also parallel to face 20. The parallelism of the outer faces (e.g., 20) is achieved by cleaving the crystal 10 along atomic planes. The channel 10 is created by physical ablation of the crystal 10.

In order to achieve laser action, a voltage is applied between the upper surface and the underside of the crystal 10. This produces a light emitting layer within the crystal 10. This light emitting layer lies parallel to the upper surface and the underside of the crystal 10. However, the channel runs sufficiently deep to interrupt the light emitting layer with the result that the crystal 10 is in actual fact divided into two separate edge-emitter semiconductor lasers, 23a and 23b. In practice, the light emitting layer would typically lie 2 μm below the upper surface. Laser 23a lies beneath metallized upper surface portion 14a and comprises a Fabry-Perot cavity whose parallel end mirrors are provided by face 20 and the wall of the channel 12 that opposes wall 22. Laser 23b lies beneath metallized upper surface portion 14b and comprises a Fabry-Perot cavity whose parallel end mirrors are provided by wall 22 of the channel 12 and the outer face of the crystal 10 that is opposite face 20. Due to their geometry, both lasers 23a and 23b produce respective laser beams that each travel back and forth within their respective Fabry-Perot cavities in a direction perpendicular to the length of the channel 12.

The width of the channel 12 is chosen relative to the divergence of the emissions that lasers 23a and 23b project into the channel such that, when the channel 12 is empty, the lasers 23a and 23b are substantially uncoupled. The introduction of material to the channel 12 however, can change the degree to which the lasers 23a and 23b are coupled. When the degree of coupling is increased, light amplified by the laser 23a is emitted into laser 23b where it undergoes further amplification, and vice versa. When the degree of coupling is increased, changes in intensity and frequency of a complex nature may occur in the laser output of the crystal 10. These changes can be observed to infer information about material in the channel 12. In one possible application, the crystal 10 is used to investigate biological cells. In such a scenario, a fluid containing biological cells to be investigated (e.g. obtained by biopsy) could be caused to flow along the channel 12 (e.g. by electrophoresis). In such circumstances the channel 12 would probably be about 20 μm deep to accommodate biological cells. An approximate analogy is to regard a cell in the channel 12 as a ball lens which refracts diverging emissions from laser 23a into laser 23b and vice versa. Different cells will of course have different effects on the coupling of the lasers 23a and 23b, meaning that different types of cell can be distinguished by their different effects on the laser output of the crystal 10.

Thus, the crystal 10 provides a sensor whose output, in the form of laser light, carries information about sample material being conveyed through the channel 12. Another embodiment will now be described, with reference to FIG. 2, in which the crystal 10 is modified to provide for detection and characterisation of laser light produced within the crystal and affected by sample material in the channel 12.

FIG. 2 illustrates a modified version of crystal 10, generally indicated 24. Features of crystal 24 that are carried over from crystal 10 of FIG. 1 retain the same reference numerals and they shall not be described in detail again. In other words, section 26 of crystal 24 can be taken to equate to crystal 10 of FIG. 1. Section 26 of crystal 24 shall be referred to as a laser section since it is in this region that laser operation occurs. The extension of the crystal deals with detection of light emitted by the laser section 26 and comprises a detector section 28 fronted by a partial mirror 30 which is separated from the laser section 26 by a channel 32. The mirror 30 is arranged to partially reflect emissions from the laser section that are travelling towards the detector section 28 and is a Bragg grating constituted by a number of additional channels 34 and 36 cut into the crystal 24. In practice, the Bragg grating comprises many more channels than just the two shown in FIG. 2. The channel 32 and the channels within the Bragg grating all run parallel to channel 12 and the opposing walls of all of these channels are parallel to one another. The reflectivity of the mirror 30 is a function of the wavelength of the incident light and this function can be selected by appropriate design of the Bragg grating that constitutes the mirror. In other words, the mirror 30 can be regarded as transducing wavelength changes into intensity changes in the part of the emissions of laser section 26 that passes through the mirror and into the detector section 28.

The detector section 28 is a part of the crystal 24 that is operated as a photodiode. Light reaching the detector section 28 from the laser section 26 induces a voltage difference within the detection section 28. The upper and lower surfaces of the detection section 28 are metal coated and provided with electrical contacts in order to enable this voltage difference to be sensed. The electrical connection to the metallized upper surface of the detection section is indicated 38 in FIG. 2. The corresponding part of the opposite face of the crystal 24 is similarly metallized and provided with an electrical connection although these elements are not shown in FIG. 2 because of the orientation of the crystal 24 in that Figure. For the avoidance of doubt, it is worth stating at this point that the underside of the laser section 26 is similarly, but separately, metallized and provided with an electrical contact although these elements are not shown, for the reasons already stated. The voltage that is measured across the detector section 28 is dependent on the intensity of the light reaching the detector section from the mirror 30 and this intensity is in turn dependent upon the design of the Bragg grating that constitutes the mirror. The transmissivity of the mirror 30 can be designed such that a wavelength change in the emissions of the laser section 26 due to a specific type of sample material can be transduced to a significant intensity change in the part of those emissions that traverses the mirror 30, which intensity change can then be registered as a significant change in the voltage across the detector section 28.

In the embodiments described so far, the metallized areas of the crystal have all extended along the whole length of the channel 12. Some embodiments will now be described in which these metallized layers are subdivided to provide discrete zones of laser action within the crystal.

The semiconductor laser crystal 40 shown in FIG. 3 is identical to crystal 10 of FIG. 1 except in that metallization of the upper and lower surfaces of the crystals is different. In FIG. 3, the metallization of the upper surface is confined to two strips, with each strip being interrupted by the channel 12. The first strip therefore appears as metallized areas 42a and 42b and the second strip appears as metallized areas 44a and 44b. The underside of the crystal 40 is provided with corresponding metallized strips, although without interruption since the channel is a feature of the upper surface only. Contacts 16 and 18 allow electrical connection to metallized regions 42a and 42b, respectively, and additional connections 46 and 48 provide electrical connection to metallized regions 44a and 44b, respectively. The metallized strips on the underside of crystal 40 corresponding to strips 42a, b and 44a, b similarly each have an electrical connection.

Metallized region 42a and its corresponding strip on the underside of crystal 40 create a first localised zone of laser action within crystal 40, that zone lying beneath metallized region 42a and constituting a first laser 41a. Similarly, second, third and fourth zones of localised laser action occur beneath metallized regions 42b, 44a and 44b respectively and constitute second, third and fourth lasers 42a, 43a and 43b respectively. The first and second lasers 41a and 41b constitute a pair whose degree of coupling is affected by material in that part of the channel 12 that is adjacent to these lasers (i.e., adjacent to metallized regions 42a and 42b). Similarly, the third and fourth lasers 43a and 43b constitute a pair whose degree of coupling is affected by material in that part of the channel 12 that is adjacent to these lasers. Thus, the crystal 40 provides two sensors, each sensor comprising one of these pairs of lasers and inspecting a different part of the channel 12. Each of these sensors can conduct an independent investigation on material in the channel 12 and functions in the same manner as the sensor provided by lasers 23a and 23b in FIG. 1. The width of the metallized strips on the crystal 40 (i.e. their extent in the direction parallel to the length of the channel) and consequently the width of the four lasers and the length of the parts of the channel that are the subjects of the two laser pairs can be made smaller than the expected dimensions of objects that are to travel along the channel for examination. This permits the sensors provided by the pairs of lasers to examine the internal structure of the objects are to be investigated. For example, the metallized strips could be made sufficiently narrow to allow the sensors to probe the interior of biological cells being conveyed along the channel 12.

FIG. 4 shows a semiconductor laser crystal 50 that is identical to crystal 24 of FIG. 2 except in that the metallization of the upper and lower surfaces has been confined to two pairs of opposing strips and in that the Bragg grating constituting the mirror 30 is cut differently for each pair of strips. No attempt has been made in FIG. 4 to illustrate the change to the Bragg grating. The strip on the upper surface belonging to the first pair appears as three metallized sections 52a, 52b and 52c, since it is interrupted at one point by channel 12 and at another point by channel 32 and the mirror 30. Electrical contact to sections 52a, 52b, and 52c is established by means of electrical connections 16, 18 and 38, respectively. The metallized strip on the underside of crystal 50 that forms a pair with strip 52a, b, c is interrupted only in the region of the channel 32 and the mirror 30, with separate electrical connections being established to the two halves of this strip.

As in FIG. 3, localised zones of laser action occur beneath metallized sections 52a, 52b, 54a and 54b providing first, second, third and fourth lasers 51a, 51b, 53a and 53b respectively. The pair of lasers 51a and 51b provide a sensor for examining material in the intervening part of the channel 12 and the pair of lasers 53a and 53b provides a sensor for examining material in the part of the channel that passes through that pair.

Metallized region 52c and the underlying half of the metallized strip on the underside of the crystal 50 together provide a localised photodiode for sensing light emerging from that part of the mirror 30 that lies between metallized section 52c and the pair of lasers 51a and 51b. Similarly, metallized region 54c and the underlying half of the metallized strip on the underside of the crystal 50 together provide a second localised photodiode for sensing light emerging from that part of the mirror 30 that lies between metallized region 54c and the pair of lasers 53a and 53b. Thus, each pair of lasers has a corresponding detector within the crystal 50. The Bragg grating constituting the mirror 30 can be cut differently in front of each of these detectors in order to allow each detector to respond to different sample material or to respond differently to the same sample material. As in FIG. 3, the width of the laser pairs and the detectors (i.e., their extent in the direction of the channel 12) can be made sufficiently small so as to permit the investigation of the internal structure of objects conveyed along the channel.

1. A semiconductor laser crystal of edge emitter type with a receptacle formed in the crystal, in which receptacle can be located sample material to be studied in order to influence the laser operation of the crystal in a detectable manner.

2. A crystal according to claim 1, wherein the crystal comprises a first pair of lasers arranged in relation to the receptacle such that sample material located in the receptacle can alter the coupling of the lasers within the first pair to influence the laser operation of the crystal in a detectable manner.

3. A crystal according to claim 2, wherein the first pair of lasers is arranged such that its coupling can be substantially altered by sample material only when that material is located in a first part of the receptacle.

4. A crystal according to claim 3, wherein said first part is smaller than the typical dimensions of a biological cell.

5. A crystal according to claim 2, 3 or 4, wherein the crystal comprises a second pair of lasers arranged in relation to the receptacle such that sample material located in the receptacle can alter the coupling of the lasers within the second pair to influence the laser operation of the crystal in a detectable manner.

6. A crystal according to claim 5, wherein the second pair of lasers is arranged such that its coupling can be substantially altered by sample material only when that material is located in a second part of the receptacle.

7. A crystal according to claim 5 or 6, wherein said second part is smaller than the typical dimensions of a biological cell.

8. A crystal according to claim 6 or 7 when dependent on claim 3 or 4, wherein said first part and said second part at least partially overlap.

9. A crystal according to any one of the preceding claims wherein the receptacle defines a flow path for conveying sample material across or through the crystal.

10. An analysis tool comprising a crystal according to any one of the preceding claims and detecting means for detecting light from the crystal's laser operation that has been influenced by sample material in the receptacle.

11. A tool according to claim 10, wherein the detector means comprises a region of the crystal, said region operating as a photodiode when stimulated by said light.

12. A tool according to claim 11, further comprising filter means for blocking certain wavelengths within said light from reaching the detector means.

13. A tool according to claim 12, wherein the filter means comprises a set of reflectors formed in the crystal.

14. A tool according to any of claims 10 to 13, wherein the detector means comprises a plurality of detectors, each detector for detecting light produced by a separate zone of laser action within the crystal.

15. A tool according to claim 13, wherein at least two detectors within said plurality experience light from the crystal's laser operation via different filter means.
